(19) United States
(12) Patent Application Publication
(10) Pub. No.: US 2017/0323273 A1
(43) Pub. Date: Nov. 9, 2017

(54) An Online Meeting System and Method

(71) Applicant: Suitebox Limited, Auckland (NZ)

(72) Inventors: Craig Meek, Auckland (NZ); Scott Judson, Auckland (NZ)

(21) Appl. No.: 15/502,224

(22) PCT Filed: Aug. 7, 2015
(86) PCT No.: PCT/NZ2015/050104

§ 371 Date: Feb. 7, 2017

(30) Foreign Application Priority Data
Aug. 7, 2014 (AU) 2014903065
Jun. 5, 2015 (AU) 2015902104

(51) Int. Cl. G06Q 10/10; G06F 3/048; G06F 17/30; H04W 12/06

(52) U.S. Cl. CPC G06Q 10/1095; G06F 3/048; G06F 17/30011; H04W 12/06; G06F 17/30174

(57) ABSTRACT

The invention provides an online meeting controller operable to connect devices having installed an online meeting application which is operable to present a user interface for the device. The user interface of each device is operable to display data from the other device so as to allow users at each device to participate in an online meeting. The controller is operable to communicate with a relationship manager which is operable to identify a user of a device as a host for an online meeting and identify a user of a device as the participant to be invited to the online meeting by the host The controller is also operable to receive first validation data which validates a device as a host device for an online meeting to be operated by a host of the meeting and second validation data which validates a device as a participant device to be operated by a participant invited to the online meeting. The controller is also operable to communicate with the application miming on a validated host device and a validated participant device so as to synchronise the user interfaces at the host and participant devices and so as to receive updates to data, documents or forms displayed at the user interfaces of the host and participant devices. The updates are inputs received at the user interfaces of the devices. The controller is also operable to communicate with a video communication system which provides a video communication service between devices. The controller initiates a video communication session through which the host device can connect with the participant device.

### FIELD OF THE INVENTION

This invention relates to a system and method for controlling online meetings and/or collaborations.

### BACKGROUND OF THE INVENTION

Online meetings and collaborations are becoming an important modern business tool. Conventionally, meeting are provided by services or applications which require participants to have an account with the service and to log in to the service before meeting online with other participants.

A plethora of online meeting services with differing functionality is emerging. Business transactions using a given service may often require an understanding of the functionality of a service, for storage of the meeting, collaboration of data, documents or forms and for recording aspects of the meeting. Often the services are not compatible with other services. Parties wishing to participate in an online meeting or collaboration may need to register with the same service before being able to meet online. Parties often need to exchange identification details specific to the service before being able to connect.

These factors present challenges to the provision of an online meeting system which provides participants with an efficient, and auditable online meeting with a rich user experience.

It would therefore be of advantage to have improvements over the prior art which addressed the above issues or at least provided the public with an alternative choice.

### DISCLOSURE OF THE INVENTION

Aspects of the present invention provide an online meeting controller which communicates with a relationship manager operable to identify a host and participant for an online meeting to validate host and participant devices to be used in an online meeting, which further communicates with applications installed on each devices to synchronise data and/or documents and/or forms presented at the user interfaces and updated in the online meeting, and to initiate a video communication session to connect the devices through the video service.

Aspects of the present invention provide an online meeting system having a meeting controller which initiates a video session with a video service between two or more devices dependent on data received by the controller from a customer relationship Management CRM service and/or database.

Aspects of the present invention provide an online meeting system having a meeting controller which initiates a video session at a video service between two or more devices upon receiving a request from a Customer Relationship Management CRM service and/or database.

Aspects of the present invention provide an online meeting system which includes a meeting controller operable to access a document stored under the control of a CRM, to transmit the document to two or more devices and to transfer the ability to control document updates between the devices to coordinate a collaboration on the document at the two or more devices and to transmit a document updated by the collaboration for storage under control of the CRM.

Aspects of the present invention provide a meeting controller operable to communicate with a pair of devices to allow alternate control and updating of a document between the devices, and operable to communicate with a video collaboration service to control a video session provided by the video service between the two devices.

Aspects of the present invention provide an online meeting service comprising a meeting controller operable to initiate a video session and invite a participant to the video session dependent on data provided by a CRM. The invite may comprise access data which allows the device to join the video session.

Aspects of the present invention provide an online meeting system which includes a meeting controller operable to initiate a video session between two or more devices using a video service, the session initiated dependent on data stored using a database managing an enterprises relationships and the meeting controller further operable to communicate with the two or more devices to allow control of the video session by one or more of the devices.

Aspects of the present invention provide an online meeting system which includes a meeting controller operable to initiate a video session between two or more devices using a video service, the session initiated using data stored by a database managing an enterprises relationships and further operable to communicate with the two or more devices to allow data and/or code from a library of code to be communicated external to the video session between the two or more devices. The database may be a Customer Relationship Management (CRM) database.

In one aspect the invention provides an online meeting controller operable to connect devices having installed an online meeting application which is operable to present a user interface for the device, wherein the user interface of each device is operable to display data and/or documents and/or video data from the other device so as to allow users at each device to participate in an online meeting, the controller being operable to:

communicate with a relationship manager which is operable to identify a user of a device as a host for an online meeting and identify a user of a device as the participant to be invited to the online meeting by the host, wherein the controller is operable to receive from the relationship management database first validation data which validates a device as a host device for an online meeting to be operated by a host of the meeting and second validation data which validates a device as a participant device to be operated by a participant invited to the online meeting;

communicate with the application running on a validated host device and a validated participant device so as to synchronise the user interfaces at the host and participant devices and so as to receive updates to data and/or documents and/or forms displayed at the user interfaces of the host and participant devices, wherein the updates are inputs received at the user interfaces of the host and/or participant devices;

communicate with a video communication system which provides a video communication service between devices, wherein the controller communicates with the video communication service to initiate a video communication session through which the host device can connect with the participant device.

The online meeting controller may be operable to communicate with the host and participant devices using a library of command code which is accessible to the controller and each device.

The online meeting controller communicate commands to the video service in response to the controller receiving command code from the host device to allow the host to control one or more functions of the video service from the host device.

The online meeting controller may be operable to control the video service to record video in response to command code received from the host device to start and stop video recording, operable to store the recorded video and operable to communicate a link to the relationship manager to allow the host operating the host device to control the capture of video from an online meeting.

The online meeting controller may be operable to control the user interface of the participant device in response to command code received from the host device to allow the user interface at a participant device to be controlled by the host to control the online meeting from the host device.

The online meeting controller may be operable in response to commands received from the host device to communicate a document or form selected from a set of documents to the participant device and to and store a version of the document updated by inputs at the participant device.

The online meeting controller may be operable to generate an invitation for a participant, the invitation containing validation data for an online meeting in response to a request received from the relationship manager.

The online meeting controller may be operable to store data and/or a document and/or a form updated in the online meeting by inputs at the user interfaces and to communicate a link to the stored data and/or documents to the relationship manager.

The online meeting controller may be operable to store the updated data and/or document and/or form in response to a command received from the host device and to store the data and/or documents dependent on a set of rules associated with the host.

The online meeting controller may be operable in response to receiving a command from the host device to transmit the data and/or document and/or form using address data associated with the participant.

The online meeting controller may be operable to synchronise data and/or documents and/or forms and store updated data and/or documents and/or forms received at the host or participant device in association with an identifier and/or key which persists over a two or more video sessions to provide an online room in which data and/or documents and/or forms can be updated between video sessions.

In another aspect the invention provides a process carried out by an online meeting controller for controlling an online meeting which connects devices having installed an online meeting application which is operable to present a user interface for the device, wherein the user interface of each device is operable to display data and/or documents and/or video data from the other device so as to allow users at each device to participate in an online meeting, the process including the steps of:

communicating with a relationship manager which identifies a user of a device as a host for an online meeting and identifies a user of a device as the participant to be invited to the online meeting by the host;

receiving from the relationship management database validation data which validates a device as a host device for an online meeting to be operated by a host of the meeting and validates a device as a participant device to be operated by a participant invited to the online meeting;

communicating with the application running on the validated host device and the validated participant device so as to synchronise the user interfaces at the host and participant devices and to receive updates to data and/or documents and/or forms displayed at the user interfaces of the host and participant devices, wherein the updates are inputs received at the user interfaces of the host and/or participant devices; and

communicating with a video communication system which provides a video communication service between devices, wherein the controller communicates with the video communication service to initiate a video communication session through which the host device can connect with the participant device.

In another aspect the invention provides a device operable to connect with another device in an online meeting the device operable to exchange command code with an online meeting controller and operable to connect to another other device through in a video communication session.

In another aspect the present invention provides an online meeting controller operable to communicate with a relationship database to receive relationship data which identifies and/or validates and/or addresses one or more parties to participate in an online meeting, the controller further operable to communicate with two or more devices using identification and/or validation and/or address data, the controller being further operable to communicate with a video communication service to initiate a video communication session and to communicate data received from the video communication service to the two or more devices to allow them to join the video communication session.

This allows connection of devices to a video communication session as determined by a relationship database. The relationship database may be a customer relationship management (CRM) database.

The online meeting controller may be further operable to communicate with the two devices by sending and receiving command code from a library of command code to control user interfaces generated by an application running on the devices to allow control of the online meeting.

The online meeting controller may be operable to control the user interfaces using the command code to display data and/or a document and/or a form received by the controller. The data and/or a document and/or a form may be received by the controller by a database. The data and/or a document and/or a form may be received by the controller by a CRM. The data and/or a document and/or a form may be received from storage in response to receiving a link, address or url from a relationship data base or CRM.

The online meeting controller may be operable to receive commands including meeting status information and to store status data which allows a host or participant to re-join an online meeting.

An online meeting may comprise user interfaces displaying data and/or documents. An online meeting may further comprise video data received by a device from the video service and combined with the user interface.

The controller may be operable to control the user interfaces to allow a user interface at a participant device to be controlled from the user interface at a host device, wherein the participant device and host devices are identified as such by data received by the controller by the CRM.

The controller may be operable to communicate session data received from the video service to the host and participant using addresses included in relations data received from the relations database to allow the host and participant to communicate through the video service.

The online meeting controller may be operable to communicate with devices identified by validation and/or identification data received by the controller from the relations database.

The online meeting controller may be operable to exchange command code from a library of command code with the devices identified.

The online meeting controller may be operable to exchange code with applications running on the two devices so as allow a document stored under the control of the database to be updated by users of the applications and to coordinate updates of the documents at the applications of the two devices.

The online meeting controller may be operable to exchange commands with applications running on the devices to control a user interface presented at one or more of the devices.

The online meeting controller may send a command to the video service to record video in response to receiving a command from one of the applications running on a device. This may be in response to the controller receiving commands from one or more of the devices to start or stop recording.

The online meeting controller may be operable to receive a link and/or address from the video service the link and/or to providing access to recorded video stored by the video service.

The online meeting controller may be operable to access the video stored by the video service, copy it to a data store and to communicate a link and/or address to the database to the video stored in the data store, whereby access to the stored video is provided by the link and/or address stored by the database.

The online meeting controller may move recorded video to a storage device which is accessible to the CRM. The meeting controller may transmit a reference to the CRM to allow access the recorded video in relation to other customer relationship management data.

The library of command code may comprise code to transfer the authority to mediate a document, the authority transferred between the devices to allow users of the devices to alternately update the session document.

The meeting control service may be operable to transmit a document to one of the devices, the document defined by data stored under the control of the CRM.

The two or more applications may be operable to combine the session document with video data received from the video collaboration service into a presentation for a user of each device, whereby the user is provided with a presentation comprising a video session via the first link and comprising a session document which is updated via the second link.

In some aspects of the present invention the meeting controller is a service. The service may be provided by a cloud stack.

As used herein the term ‘service’ applies broadly to a service provided computer systems, or applications such as cloud stacks or by other computer applications.

As used herein the term ‘database’ refers broadly to a structured computer storage facility.

As used herein the term ‘relationship database’ refers broadly to a database for which the structure or data stored defines relationships between parties or devices.

In some aspects of the present invention the structure or data of a database defines the relationship that two parties or devices are to be connected on an online meeting or through and online meeting room.

In aspects a relationship database the structure or data defines the relationships between parties and an enterprise. In some aspects this is that a party is an agent of an enterprise. In some aspects this is that a party is an agent of a member of an enterprise. In some aspects this is that a party is authorised to access details of customers or other parties associated with an enterprise. In some aspects this is that a party is an authorised host operable to invite parties into an online meeting room or online meeting room. In some aspects this is that a party is an authorised host operable to initiate an online meeting or online meeting room.

As used herein a ‘server’ is a computer and/or cloud facility which manages access to a resource or facility. In some aspects the resource includes a set of forms. In some aspects the facility is storage of data input at user interfaces at devices.

As used herein the term ‘device’ refers broadly to a device with computing or processing functionality.

As used herein the term ‘application’ refers broadly to software which performs a purpose, and includes for example script running on a browser application.

As used herein the term ‘online meeting’ refers broadly to a computer, Internet, web, or cloud facility which allows parties to interact with each other.

As used herein the term ‘form-collaboration session’ refers broadly to a session in which each of a number of parties are able to update a form displayed to the parties. In some aspects of the present invention updates comprise adding or adjusting data associated with the form.

As used herein the term ‘online meeting room’ refers broadly to a computer, internet, web, or cloud facility which allows parties to enter and leave to update documents or data or to connect in meetings and which persists to allow multiple updates or meeting.

In some aspects of the present invention a service is operable to receive requests at an address and to provide responses. In some cases the requests, responses and addresses may be defined in an application programming interface (API).

In another aspect the present invention provides an online meeting controller operable to connect devices having installed an online meeting application which is operable to present a user interface for the device, wherein the user interface of each device is operable to display a form data entered at one or more of the devices so as to allow users at each device to participate in an online collaboration, the controller being operable to:

communicate with a relationship database which is operable to identify a user of a device as a host for an online meeting and identify a user of a device as the participant to be invited to the online meeting by the host, wherein the online meeting controller is operable to receive from the relationship management database validation data which validates a device as a host device for an online meeting to be operated by a host of the meeting and validates a device as a participant device to be operated by a participant invited to the online meeting; and wherein the online meeting controller is operable to store the form data and the signature data;

communicate with the application running on a validated host device and a validated participant device so as to synchronise the user interfaces at the host and participant devices and so as to receive form data entered in fields of forms displayed at the user interfaces of the host and participant devices and so as to receive signature data capturing a signature made at one or more of the devices,

retrieve a set of stored evidencing rules associated with the host, the rules defining one or more operations for the online meeting controller and including one or more addresses and/or endpoints transmission of form data and signature data; and

generate an evidencing transmission carrying form data and signature data, wherein the evidencing transmission is generated dependent on a set of evidencing rules associated with the host.

The evidencing rules may be associated with the host through a stored association between the host and an enterprise, the association stored by a relationship database.

The online meeting controller may be operable to communicate with a video communication system which provides a video communication service between devices, wherein the controller communicates with the video communication service to initiate a video communication session through which the host device can connect with the participant device.

Aspects of the present invention provide a server which communicates with two or more devices in an online form-collaboration session and/or online meeting and/or online meeting room, each device displaying a user interface with one or more fields of a form to be executed, the server being operable to receive form data entered at the one or more user interfaces and associated with the one or more fields of the form and to receive signature data from one or more of the devices and to aggregate the form data and signature date dependent on a session key, or room key, identifying an online form-collaboration session, or online meeting room, in which form data was received at the user interfaces. The online form-collaboration session may be an online meeting.

Aspects of the present invention provide a server which communicates with two or more devices in a form-collaboration session and/or online meeting and/or online meeting room, each device displaying a user interface with one or more fields of a form to be executed, the display rendered dependent on a form template defining fields of the form and configuration data defining a configuration for the form, the server being operable to receive form data entered at the one or more user interfaces and associated with the one or more fields of the form and to receive signature data from one or more of the devices, wherein the server communicates with the two or more devices using a library of commands which allows the configuration data to be changed at one of the devices to allow a user at that device to control the configuration of the form and/or user interface. The online form-collaboration session may be an online meeting.

Aspects of the present invention provide a server which communicates with two or more devices participating in an online form-collaboration session and/or online meeting, each device having a user interface displaying one or more fields of a form to be executed, the server being operable to receive form data associated with the one or more fields of the form, to receive signature data from one or more of the devices and to generate evidencing transmissions carrying form data and signature data, the evidencing transmissions being generated dependent on one or more evidencing rules defined for an enterprise associated with one or more of the devices. The enterprise may be associated with the one or more devices by relationship data defining associations between operators of each of the devices and an enterprise for which a set of stored evidencing rules are retrieved by the server. The relationship data may be stored in a relationship database, such as a customer relationship database or an employment relationship database. This allows the form to be completed and signed in the online meeting and evidenced by storage dependent on rules defined for the enterprise. The online form collaboration session may be an online meeting.

Aspects of the present invention provide a server which communicates with two or more devices participating in a an online meeting or online form-collaboration meeting, each device having a user interface, the server operable to communicate with the devices using a library of commands so as to synchronise the user interfaces at the devices and/or data and/or a document and the devices.

The server may communicate to update the configuration or data displayed or entered in forms displayed at the user interface of one device to synchronise it with user interface of another device.

Synchronisation may comprise switching control of the interface from one device to the other.

The server may be operable to synchronise the display such that the user interface of a first device is synchronised to the user interface of a second device while that other device logs in to a system external to the controller.

The user interface may be operable to display and receive inputs at one or more fields of a form to be executed. The display may be operable to receive a set of coordinates to capture a signature of a user.

The server may be operable to aggregate form data dependent on a form template which carries a description of the fields of a form into which data is input.

The form may be rendered for display dependent on the form template.

The form template may be sent to the devices by the server.

The server may communicate configuration data from a device acting as a host of the online meeting to a device acting as an invited participant to the online meeting wherein the configuration data defines the configuration of the user interface and/or the form displayed at the participant device.

The server may allow the form template received by the devices from the server to be selected from a set of form templates at the user interface of the device acting as the host of the online meeting.

The server may be operable to send an invite upon receiving a request from the device acting as the host, the invite carrying invite data which allows the device acting as the participant to join the online meeting.

The invite data may comprise data held by a database storing relationship data defining candidate host devices and participant devices of an associated enterprise. The invite data may be validation data.

The configuration data may include data determining whether a given device has the moderation right allowing changes to be made at that device to form data entered for fields of the form, the configuration data allowing moderation of the form to be transferred between the devices under the control of one device. The device not having the moderation device may disable one or more fields of the form to prevent form data being entered at that device.

The configuration data may include data which determines whether selected fields are enabled.

The configuration data may include data which determines whether selected fields are filled automatically using data from a CRM/ERM and/or data base which stores data defining the relationship of a device or it's user to the enterprise.

In one aspect the present invention provides a server operable to communicate with two or more devices in an online meeting, wherein the server is further operable to cause the form data to be stored according to a stored set of rules.

The rules may define one or more storage locations, endpoints or addresses for form data.

The rules may define operations to combine any of the following in an evidencing transmission or email: form data, signature data, a form template, time stamp data, a session or meeting key.

The server may be operable to communicate with the devices using a library of commands to receive data from one or more of the two or more devices.

The server may be operable to communicate with two or more devices which share a session key to identify a collaboration session in which a form is executed.

The server may be operable to aggregate the received data dependent on is the session key to allow data entered at a user interface at one or more of the devices to be stored as form data associated with the session. This may allow a transaction made in the online meeting with form data to be evidenced by the server according to defined.

The form data may include signature data. The signature data may be received separately to form data from one of the devices.

The server may be operable to store a set of rules for each of a set of enterprises. The server may be operable to retrieve a set of rules describing storage locations for the respective enterprise. The rules may be retrieved dependent on data which associates one or more of the devices and/or one or more users of one of the devices with an enterprise. This may allow each enterprise represented by given operators of host devices to define a bespoke set of rules for evidencing transactions made in online form-collaboration sessions or meetings.

The server may comprise a rules interface operable to allow rules to be entered and/or updated.

The server may comprise a rules interface operable to allow rules to be viewed.

The server may be operable to store the form data dependent also on address data stored for candidate participants associated with the enterprise.

The server may be operable to transmit form data dependent on data stored in the database which stores data defining the relationship of the devices or users to the enterprise.

The server may be operable to generate a document including form data received in a session.

Form data may comprise a set of records each associated with a field of a form.

The server may store a form template describing fields.

The library of commands may comprise commands which allow a user interface operable to receive form data at one device to be controlled by inputs at another device in a session. The server may be operable to exchange commands with the devices so as to maintain synchronisation of user interfaces and/or form displays at the devices. The server may be operable to exchange commands so as to determine whether synchronisation of the user interfaces at the devices is lost. The server may be operable to exchange commands so restore synchronisation of the user interfaces at the devices in the event that synchronisation is lost,

The server may be operable to communicate with the two or more devices dependent on data received from an enterprise relationship database or customer relationship database.

The server may be operable to initiate a video session with a video service and to provide video session data to allow the devices to connect through the video session and to communicate with the devices in parallel to the connection through the video session to receive form data entered at the devices and/or to allow one device acting a host to control the user interface of the other device displaying the form.

Aspects of the present invention provide a server operable to generate an invitation carrying invitation data which allows a participant device to join an online meeting, form-collaboration session or video session. The invitation transmission may be generated in response to a command received from a host device. Alternatively invitation transmission may be generated in response to a command received from a relationship manager. The relationship manager may be a database. The invitation transmission may be generated dependent on address and or relationship data stored for an enterprise. The invitation transmission may be generated dependent on address and or relationship data stored in association with the host device or identification data for the operator of the host device.

Further aspects of the present invention provide servers and/or devices and/or servers and/or systems suitable for online meetings and having features or any of the paragraphs above.

Further aspects of the invention comprise any combination of the features described herein.

Further aspects provide an application installable on a device comprising any combination of the features described herein.

Further aspects provide a system on a device comprising any combination of the features described herein.

Various further aspects of the present invention comprise each of all possible combinations of features included in the paragraphs above.

In some aspects of the present invention the term controller includes a server.

In some aspects of the present invention the term server includes a server operable to act as a controller as described herein.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows the architecture of an online meeting system according to a preferred embodiment of the present invention;

FIG. 2 shows a process for online meeting setup according to the same embodiment of the invention as FIG. 1;

FIG. 3 shows a process for login of a device operated by a host of an online meeting according to the same embodiment of the present invention as FIGS. 1 and 2;

FIG. 4 shows a process for login of a device operated by a participant, invited to an online meeting by a host, according to the same embodiment of the invention as FIGS. 1 to 3;

FIG. 5 shows a process for opening a two way video session between devices operated by the host and participant according to the same embodiment of the present invention as FIGS. 1 to 4;

FIG. 6 shows a process of presenting a set of documents held by a customer relationship management database at a device under the control of a meeting controller according to the same embodiment of the present invention;

FIG. 7 shows a process for selection of a document presented by the process of FIG. 6;

FIG. 8 shows a process for storing the status of an online meeting according the embodiment of the present invention as FIGS. 1 to 7; and

FIG. 9 shows a system according to another embodiment of the present invention for online collaborations involving forms. Further aspects of the invention will become apparent from the following description of the invention which is given by way of example only of particular embodiments.

### BEST MODES FOR CARRYING OUT THE INVENTION

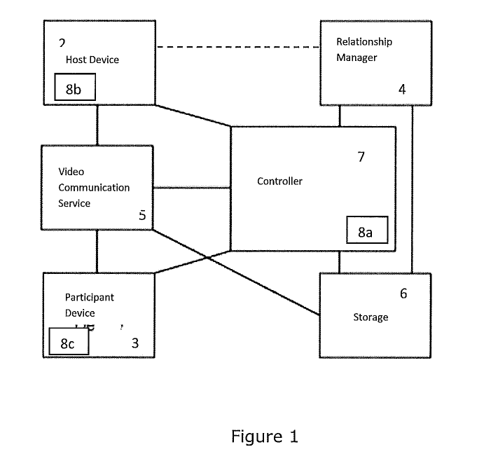

FIG. 1 shows the architecture of an online meeting system 1 according to a preferred embodiment of the present invention.

A host device 2, in the possession of a host of an online meeting, is shown in FIG. 1. Typically, a host is a party identified as a member of an enterprise who may invite participants to on-line meetings as part of the customer relationship management operations of the enterprise. The host is identified as a host by a relationship manager 4. In this example the relationship manager is a Customer Relationship Management (CRM) database 4, but other types of databases, applications or services may be used.

The host device 2 has an online meeting application (app) installed. The application presents a graphical user interface (GUI) to the host. The GUI in this example displays data and/or documents which can be updated in an online meeting. The GUI and data and/or documents displayed at the host device 2 in this example can also be synchronised to a similar GUI at another device in an online meeting. The GUI can also display video data captured at another device and the application can control the device 2 to capture video. The captured and displayed video data can be included in an online meeting.

Also shown in FIG. 1 is a participant device 3, in the possession of a participant invited to an on-line meeting with the host. The participant device 3 also has an online meeting app installed. In this example, the app installed on this device is the same as the app on the host, but runs under different conditions and/or permissions based on a participant login as opposed to a host login.

FIG. 1 shows an online meeting controller 7 in communication with the host device 2 and participant device 3. The online meeting controller 7 communicates with the applications at the host device and participant device using command code from a library of code 8. The library is retrievable by the controller 7 and the apps at each device 2 and 3.

The controller 7 is able to exchange command code with the apps is installed on each device 2 and 3. This exchange of command code provides an online meeting communication channel. The channel has low latency and requires only low data transmission by nature of using defined command code.

The controller 7 uses the exchange of command code to synchronise the apps at the host device 2 and participant device 3. Specifically in this example, the controller uses the online meeting communication channel to synchronise the GUIs at the host device 2 and participant device 3 so that updates to a document or data entered into a document or form appears at both devices. More specifically in this example, data and/or documents presented at the GUI and updated using the GUI of either device is synchronised by the controller 7 using the communication channel. More generally the configuration of the GUI is synchronised between the two devices. This configuration may be which menus or tabs have been selected, which fields of a form are enabled or disabled for data input, which tabs or pages are open, where in a document is the cursor, whether the meeting room has a host or participant in attendance, or other aspects of a GUI for an online meeting or online meeting room that will be apparent to the reader.

In this embodiment, the Graphical User interface (GUI) at the participant device 3 has disabled, hidden or omitted some of the control buttons presented at the host device 2. In this example the app installed on the participant device does not allow a user logged in as a participant to control the meeting. This meeting is controlled by permissions set from the meeting controller 7 on login as illustrated below.

The app installed at the host device allows a user logged in as a host to shift the control or moderation of documents to the participant. The participant is able to scroll, pinch and zoom the current document. The moderation right of the document alternates between the host device 2 and participant device 3. In this embodiment these controls will be reflected at the GUI of the other device in a meeting which is synchronised to the GUI of the first device by the controller 7.

FIG. 1 also shows a Customer Relationship Management (CRM) service 4. In this embodiment the CRM is a cloud service provided by an application running on cloud infrastructure, such as a cloud stack.

The CRM 4 stores data which identifies hosts and participants for an online meeting. The CRM 4 may be recognised as a relationship manager for online meetings. In this example, the CRM stores the host and participant's relationship to each other. For example, the host is identified as a party able to host a particular meeting and the participant is a party which the particular host can invite to the online meeting. The host and participant's relationship to a host to an enterprise is also stored by the CRM in this embodiment. The host may be identified by the CRM 4 as the host of a particular meeting or as one of the hosts which can invite given of the participants associated with an enterprise to a meeting. The CRM 4 may store data identifying a host as the host of a meeting requested by the host. The CRM 4 may store data which identifies a host as belonging to a set of parties authorised to host meetings. This authority may be associated with data identifying a given enterprise or organisation. For example, a host may be a party requesting an online meeting be established and the CRM may store data identifying parties that the host can invite to an online meeting. The CRM 4 also identifies the host and participant as such for a given online meeting,

In this embodiment the CRM 4 is able to initialise an on-line meeting and communicate meeting details to other actors in the system 1. Initialising an online meeting in this example involves a key or other data which identifies a particular meeting being stored. The key can be used to reference video, data and/or documents from the meeting.

In this embodiment also the CRM 4 stores data to validate the host and participant. Also in this embodiment the CRM 4 allows access to video data and/or documents stored in relation to a participant of an online meeting. The CRM 4 of this embodiment further stores a CRM activity status, and updates the CRM activity status with links to any video recordings of online meetings and references to documents which may have been presented or updated in an online meeting. In this embodiment also, the CRM 4 is able to send a request for an online meeting to the online meeting controller 7. The CRM 4 can include any of the above data, statuses or links in the request for an online meeting.

Also shown in FIG. 1 is a video service 5. The video service 5 in this embodiment is a cloud service. The video service 5 is able to communicate with various devices to provide video communications between the devices in a video session.

In this embodiment the video service 5 is able to receive requests to create a video session. In response to receiving a request the video service 5 provides a video session key which can be passed to the devices 2 and 3 to access the video session. The video service of this embodiment is also able to provide an API (Application Programming Interface) url for connecting to a video session.

The meeting controller 7 is able to store a video service url, API key and secret token received from the video service. The meeting controller is then able to communicate data carrying these credentials to the host device 2 and participant device 3 to enable them to connect to each other via the video service.

Also in this embodiment the video service is able to receive requests to start recording and stop recording video sessions and to record video accordingly.

A data store 6, also shown in FIG. 1, stores recorded video. In this embodiment the data store is a cloud data storage service.

In this embodiment, a host device 2 is able to enable and disable the recording of a video session to create video recordings which are stored in the data store 6. Functions available to the host in this embodiment include start video recording, stop recording video and store video.

In the system 1 illustrated above with reference to FIG. 1, the online meeting controller 7 is able to set up a meeting between the apps at the host and participant devices 2 and 3, to set up a video session at the video service 4 and act as a gatekeeper between the host and participant devices 2 and 3 and the video session. The video session may be initiated for an ongoing online meeting. As illustrated the online meeting controller is a stand-alone actor or service in the system 1.

In addition to communicating with the devices 2 and 3, the controller 5 is also able to communicate with the CRM to use CRM data stored by the CRM. The online meeting controller 7 is able to use this data to set up meetings, validate hosts, and generate communications for a participant to allows them to login to the CRM 4. When a meeting has been setup in the CRM 4, in this example, the meeting controller 7 emails the participant with a “single click” login email containing code allowing access to the meeting through the controller 7. The email to the participant involves the controller 7 generating an email using the participants address received in data from the CRM 4.

The controller 7 is able to communicate with the CRM 4 to confirm the host at device 2 is valid and that the participant is validated within the meeting controller 7. The controller 7 is able to coordinate a video session with the video service once both parties at devices 2 and 3 have logged in to the online meeting.

Also shown in FIG. 1 is a library 8 of command code stored at the controller 7 as well as applications of devices 2 and 3. Communication using the library 8 provides a meeting communication channel which synchronises applications running at each of the devices 2 and 3 and communicates any relevant task requests from the devices to the controller 7. The use of command code allows communication at low latency.

The controller 7 of this embodiment is able to store a state for both users at all times. This enables parties at either device 2 or 3 to disconnect and reconnect into the correct meeting.

In this example, the states stored include one or more of the following: whether the host and participant are validated for given online meetings, whether the host and participant devices are connected in the meeting, whether the host and participant devices are connected to each other by video.

The controller 7 enables a host to review a video at the GUI at the host device. To do this, the controller 7 is able to transmit a temporary link to a video recording stored by the data store 6 to the CRM at the request of the app at the host device 2.

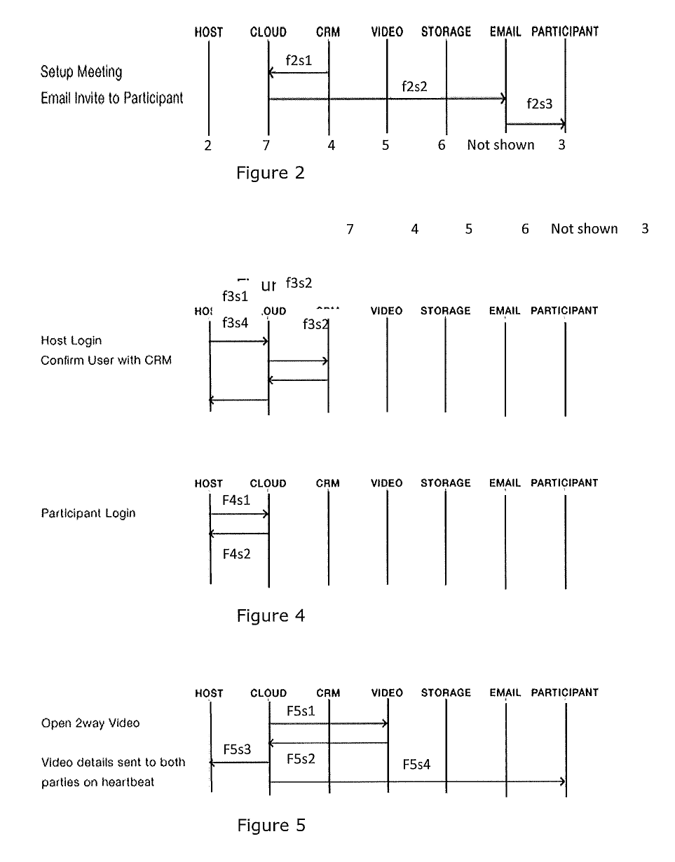

The present invention is further illustrated below with reference to FIGS. 2 to 7 which show example processes carried out by the online meeting system 1. Each of the FIGS. 2 to 7 have a ‘swim lane’ representing actions taken by one of the actors of the system 1. The ‘swim lanes’ shown from left to right represent: the app running on a host device 2, the controller implemented in this embodiment as the cloud stack or ‘cloud’ 7, the CRM 4, the video service 5, a data store 6, an email application (not shown) and the app running on a participant device 3. Steps in processes are shown as arrows between swim lanes representing actors in the system of FIG. 1 involved in the steps, with the order of steps starting with at the top of the diagram downwards. Steps 1 to n of FIGS. 2 to 7 will be referenced as f2s1 to f7sn, for example.

FIG. 2 shows a process according to the present embodiment of the invention in which an online meeting is setup from within the CRM 4.

At step 1 of FIG. 2, f2s1, the CRM 4 communicates a meeting request to the meeting controller 7. The request contains CRM data, or relationship data> The data carries a username, identification and address data for a host, a name, ID data and address data for a customer, to be invited as a participant to an online meeting. The participant is typically a customer or contact of the enterprise of which the host is a member. The relationship of the host and customer, or participant, is stored in this example as data associating the host and customer with an enterprise.

TABLE 1

| | |
|---|---|
| 1. | From CRM to Cloud |

```
{
  “SbxMeetingRequest”: {
  “Meeting”: {
    “activityID”: “1”,
    “activityTitle”: “Suitebox Meeting”,
    “activityTime”: “1404214200”,
    “activityLength”: “999”,
    “TimeZone”: “Auckland/NZTZ”,
    “UserID”: “314”,
    “UserName”: “Scott Judson”,
    “hostEmail”: “scott@suitebox.com”,
    “SiteOwnerId”: “156”,
    “Participants”: {
    “Participant”: {
      “CustomerID”: “25225”,
      “CustomerName”: “Leroy Jenkins”,
      “CustomerEmail”: “pedro.tokarski@asparona.com”
    }
    }
  }
  }
}
```

At step f2s2 the controller 7 communicates a login address by email using the customer address in the CRM data received in the meeting request at step f2s1. In this example the controller 7 generates an email s transmission which includes the customer email address included in the request from the CRM.

TABLE 2

No table 2.

FIG. 3 shows a process by which a host device 2 is validated as a host logs in to the system 1.

At the step in FIG. 3 shown as step 1 (f3s1) the app of a host device 2 communicates a login request to the controller 7. The request carries a username and password.

Table 3 shows a login request from an app running on a host device 2.

TABLE 3

From Host to SBx cloud
{“SbxLoginRequest” : {“username”:“scott@suitebox.com”,
“password”:“zaq123”}}

At f3s2 the controller 5 communicates a request for validation to the CRM. In this example this validation request conforms to code defined by the API of a given CRM service. Table 4 shows an example request according to the present embodiment.

TABLE 5
From Cloud to CRM
https://testapi.exsalerate.com/api/SiteUser?userId=314&userName=Scott
Judson

At f3s3 the CRM 4 communicates a validation response to the controller 7. The validation response includes a Boolean value showing whether the validation was successful and also includes validation data carrying a site user Id for the validated host. The Boolean and site user ID are preceded by the command code ‘result’. Table 5 shows an example response according to the present embodiment.

TABLE 6

```
From CRM to Cloud
{
“result”:{
        “success”:true,
        “data”:{“SiteUserId”:314}
        }
                                }
```

At f3s4 the controller 7 communicates data to the app running on the host device 2. Data sent in this transmission typically includes session is token, meeting ID, and CRM data including a customer ID for a participant, customer name and an address for the participant to be invited. The data is preceded by command code from the library of command code. Table 7 shows an example communication for step f3s4.

TABLE 7

```
1.  From Cloud to Host
    {
      SbxLoginResponse =  {
        meeting =  {
          Participants =  {
            Participant =  {
              CustomerEmail = “tj@seamonkey.me”;
              CustomerID = 25244;
              CustomerName = “Leroy Jenkins”;
            };
          };
          TimeZone = “Auckland/NZTZ”;
          UserID = 314;
          UserName = “Scott Judson”;
          activityID = 39482;
          activityLength = 900;
          activityTime = 1405467000;
          activityTitle = “Test meeting”;
          hostEmail = “scott@suitebox.com”;
          meetingID = 701;
        };
        statusList =  {
          “@size” = 1;
          status =  {
            statusCode = 200;
            statusMessage = Authenticated;
          };
        };
        token = 2d383038303239393838323235333939;
      };
    }
```

FIG. 4 shows a process in which a participant is invited to an online meeting with an email generated and sent according to step 4 of FIG. 3 (f3s4).

At step f4s1 the app of the participant device 3 communicates a login request to the controller 7. The request contains login data including the form of a username, address and password. The password is used to validate the device as being in the possession of a participant invited to the meeting. In this example the login data was included in an invite email generated by the controller 7.

Table 5 shows an example login request used in step f4s1.

TABLE 5

From Participant to SBx cloud
{“SbxLoginRequest” : {“username”:“craig@suitebox.com”,
“password”:“297594”}}

At step f4s2 the controller 7 communicates a response to the app of the participant device 3 after a successful login. In this example the login is validated internally in the meeting controller using validation data received from the CRM 4. The response at step f3s2 contains participants, title and time of meeting, length of meeting and a session token. At this point both devices 2 and 3 are connected by the installed apps to the controller 7 in an online meeting which allows the controller synchronise the apps, GUIs and data and/or documents displayed by the GUI.

Table 6 shows an example response from the controller 7 to the app of the participant device, once validated, to log in the device.

TABLE 6

```
From Cloud to Participant
{
  SbxLoginResponse =  {
    meeting =  {
      Participants =  {
        Participant =  {
          CustomerEmail = “craig@suitebox.com”;
          CustomerID = 25244;
          CustomerName = “Lightbulb Moment”;
        };
      };
      TimeZone = “Auckland/NZTZ”;
      UserID = 314;
      UserName = “Scott Judson”;
      activityID = 39482;
      activityLength = 900;
      activityTime = 1405467000;
      activityTitle = “Video Meeting”;
      hostEmail = “scott@suitebox.com”;
      meetingID = 701;
    };
    statusList =  {
      “@size” = 1;
      status =  {
        statusCode = 200;
        statusMessage =  (
        );
      };
    };
    token = 35313534393039393334323233303336;
  };
}
```

FIG. 5 shows a process in which the controller 7 initiates a video session to connect apps installed at host and participant devices 2 and 3. In this example, the video session is initiated after the devices have logged into an online meeting as identified by a meeting ID.

At step f5s1 the controller 7 communicates a command to the video service 5 to create a video session as shown by example in Table 7. In this example the command is defined by the API of the video service.

TABLE 7

1. From Cloud to Video
https://api.xxxx.com/hl/session/create

At step f5s2 the video service 5 transmits session data to the controller 7. The session data includes a session ID, a partner ID, a session date and session status as shown in Table 8.

The meeting controller 7 stores the video service url, API key and a secret token. In this example the meeting controller 7 starts a video session with the video service 5. The video service 5 sends the meeting controller 7 a session ID and session token. The meeting controller 7 then sends these credentials to the host and participant to connect to each other through is the installed apps and the video service 5. At this point, in this embodiment, the devices 2 and 3 are connected in a video communication session through the video service 5 and are also both connected to the controller 7 in an online meeting to control and synchronise the GUIs and data and/or documents displayed by the GUI.

TABLE 8

```
1.  From Video to Cloud
    <sessions>
    <Session>
      <session_id>SESSION_ID</session_id>
      <partner_id>API_KEY</partner_id>
      <create_dt>DATE</create_dt>
      <session_status></session_status>
    </Session>
    </sessions>
```

At step f5s3 the controller 7 communicates video session data and meeting status data to the apps of the host and participant devices 2 and 3 to allow them to join the video session and establish a video link through the video service 5. Video data received from the video service 5 is combined with form data and documents at the GUI presented by the apps. An example communication for this step is given in Table 9.

```
TABLE 9
1.  From Cloud to Host & Participant
    {
      SbxHeartbeatResponse =  {
        statusList =  {
          “@size” = “”;
          status =  (
                  {
              statusCode = 1026;
              statusMessage =
    “T1==cGFydG5lcl9pZD00NDcyNDAyMiZzaYmQxZTE5NjliOG
    Q3YTpzZXWc9ZmE2ZmY1NmM0ZTl2Mjg1OGFjZjE0OTlzYzRm
    NzaW9uX2lkPTFfTVg0ME5EY3lOREF5TW41LVZlVmxJRXAxYk
    NBeE5TQXhOam94T0RveU9TQlFSRlFnTWpBeE5lNHdMamd3T
    1Rjd01EWi1mZyZjcmVhdGVfdGltZT0xNDA1NDY2MzA3Jm5vbm
    NlPTE4MjlwMjMxNjgmcm9sZT1wdWJsaXNoZXl=”;
            },
                  {
              statusCode = 1027;
              statusMessage = “1_MX40NDcyNDAyMn5-VHVllEp1
    bCAxNSAxNjoxODoyOSBQRFQgMjAxNH4wLjgwOTcwMDZ-fg”;
            }
          );
        };
      };
    }
```

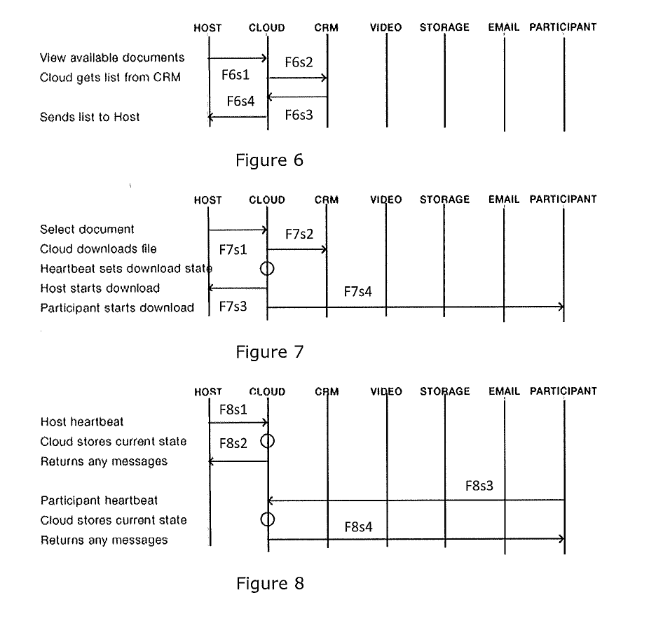

FIG. 6 shows a process by which a list of documents stored by the CRM 4 is made available for presentation at the GUI (not shown) of the app running on the devices 2 or 3. In this particular example, a host is able to select a document from the list with suitable inputs at the GUI.

At step f6s1 a document list request is communicated to the controller 7 by the app running on the host device 2 using a command code SbxDocumentListRequest. The request contains a token communicated to the host by the controller 7 in step f2s3. Table 10 shows an example request used in this step.

TABLE 10

```
1.  From Host to Cloud
    {“SbxDocumentListRequest” ;
    {“token” ; “2d383038303239393838323235333939”}}
```

At step f6s2 the controller communicates a request to the CRM 4. The request in this example includes CRM data including a customer ID for the participant, being identified as a customer of the enterprise using the CRM 4. Table 11 shows an example request used in this step.

TABLE 11

```
1.  From Cloud to CRM
    https://testapi,exsalerate.com/api/Document?siteOwnerId=
    156&customerId=25225
```

At step f6s3 the CRM communicates a response to the request of f6s2 which includes a list of documents linked to the participant or customer. An example response is shown in Table 12.

TABLE 12

```
1.  From CRM to Cloud
    {
    “result”:{
      “success”:true,
      “data”:{
        “Documents”:[
          {
            “Title”:“SuiteBox Video CRM User Guide”,
            “DocumentId”:275,
    “URL”:“https://api.exsalerate.com//api/Document?siteOwnerId=
    156&customerId=25225&documentId=275”,
              “Size”:“5.1 MB”
            },
            {
              “Title”:“Working in the cloud”,
              “DocumentId”:276,
    “URL”:“https://api.exsalerate.com//api/Document?siteOwnerId=
    156&customerId=25225&tdocumentId=276”,
              “Size”:“372.8 KB”
            }
          ]
        }
      }
    }
```

At step f6s4 the controller 7 communicates a response to the app running on the host device 2. The response contains code with a list of documents available to introduce into the meeting.

```
TABLE 13
1.  From Cloud to Host
    SbxDocumentListResponse =  {
        documentList =  {
          “@size” = 1;
          document =  (
                  {
              customerID = 25244;
              documentID = 294;
          participantProgress = “-”;
          progress = “-”;
          siteID = 156;
          size = “5.1 MB”;
          title = Workflow;
          url = “https://cloud.suitebox.com/SuiteBox-
    FileDownloadServlet-context-root/ExsalerateDocumentDownload?s=
    156&c=25244&d=294&v=MTU2WUhORVNXUVBPTUhGRFleJk
    5lRkMyNTl0NFllTkVTV1FQT01lRkRZXiZOSEZDMjk0WUhORV
    NXUVBPTUhGRFleJk5lRkM=”;
            };
        );
      };
    }
```

FIG. 7 shows a process by which a document in the list provided by the process of FIG. 6 and linked to a customer of an enterprise in CRM data stored by the CRM 4 is selected and downloaded to the apps running on the devices 2 and 3.

At step f7s1 the host device 2 communicates a request to the controller 7 to select and download a document from a list downloaded at step f6s4 and presented at the GUI of the host device 2.

The host device 2 communicates a request to the meeting controller 7 including a meeting token, code (status 1009, requesting a document be downloaded) and the file name, URL and file size.

```
TABLE 14
    1.  From Host to Cloud
  {“SbxHeartbeatRequest” : {“token” :
    “2d383038303239393838323235333939”, “status” : “1009”,
    “statusMessage” : “SuiteBox.pdf!!https://cloud.suitebox.com/
                SuiteBox-FileDownloadServlet- context-root/
ExsalerateDocumentDownload?s=156&c=25244&d=294&v=MTU2WU
    hORVNXUVBPTUhGRFleJk5lRkMyNTl0NFllTkVTV1FQT01lR
    kRZXIZOSEZDMik0WUhORVNXUVBPTUhGRFleJk5lRkM=!!-
                            !!5.1 MB”}}
```

At step f7s2 the controller 7 communicates with the cloud with a document query containing a customer ID and a document ID.

The meeting controller 7 creates the relevant URL for the CRM 4 to get the file and copy it back to the meeting controller 7. This is done in order to maintain tight security between the CRM and meeting controller 7.

It will be apparent to the reader that the controller is acting between the host device 2 and CRM 4 for document access.

TABLE 15

```
1.  From Cloud to CRM
    https://testapi.exsalerate.com/api/Document?siteOwnerId=
    156&customerId=25225&documentId=260
```

At step f7s3 the meeting controller 7 receives the correct document from the CRM 4.

TABLE 16
Null

1. From CRM to Cloud

s At step f7s4 the controller 7 communicates with the participant device 3 via the code library 8 to download the document required. The heartbeat includes the status 1009 (this means download a document) and the message that contains the file name, URL and file size.

```
TABLE 17
1.  From Cloud to Participant
    SbxHeartbeatResponse =  {
        statusList =  {
          “@size” = 1;
          status =  {
            statusCode = 1009;
            statusMessage = “SuiteBox.pdf!!https://cloud.suitebox.com/
    SuiteBox-FileDownloadServlet-context-
    root/ExsalerateDocumentDownload?s=156&c=25244&d=294&v=
    MTU2WUhORVNXUVBPTUhGRFleJk5lRkMNTlONFllTkVTV1F
    QT01lRkRZXiZOSEZDMjk0WUhORVNXUVBPTUhGRFleJk5l
    RkM=!!-!!5.1 MB”;
          };
        };
                                }
```

At step f7s5 the Participant 3 and host 2 informs the meeting controller 7 that it has completed downloading the document by both sending the communication of Table 18.

TABLE 18

```
1.  From Participant to Cloud
    {“SbxHeartbeatRequest” :
    {“token” : “35313534393039393334323233303336”, “status” :
    “1010”, “statusMessage” : “Document Download”}}
```

At step f7s6 the meeting controller 7 sends a message to the host device 2 stating that the participant device has completed downloading the document. This GUI (not shown) presented by the app running on the host device displays code indicating the fact that the document was downloaded.

TABLE 19

| | |
|---|---|
| 1. | From Cloud to Host |

```
SbxHeartbeatResponse = {
    statusList = {
      “@size” = 1;
      status = {
        statusCode = 1010;
        statusMessage = “Document Download”;
      };
    };
  }
```

FIG. 8 shows a process by which a video communication session is in recorded at the request of a host at the GUI presented by the app running on the host device 2.

At step f8s1 a record button is activated at the GUI presented by the app running on the host device 2. The host device 2 communicates a request to Start Recording to the meeting controller 7. This includes the Session ID, Recording Name (this is made up of the meeting name and a timestamp) and the token.

TABLE 20

From Host to Cloud
{“SbxStartRecordingRequest” : {“sessionID” :
“1_MX40NDcyNDAyMn5-V2VklEp1bCAxNiAyMTo0N-
TowMyBQRFQgMjAxNH4wLjA1NDA0Mjlyfn4” ,
“recordName” : “Sales_Discussion_1458” , “token” :
“34363035333839373030373134373138”}}

At step f8s2 the meeting controller 7 sends a message to the video service containing the session ID and the recording name. This instructs the Video Service to start recording the video session.

```
TABLE 21
  From Cloud to Video
  {
    “sessionId” : “1_MX40NDcyNDAyMn5-
V2VklEp1bCAxNiAyMTo0NTowMyBQRFQgMjAxNH4wLjA1NDA0-
Mjlyfn4”,
    “name” : “ Sales_Discussion_1458”
  }
```

At step s8s3 the Video Service returns notification that it has started.

```
TABLE 22
From Video to Cloud
{
  “createdAt” : 1384221730555,
  “duration” : 0,
  “Id” : “b40ef09b-3811-4726-b508-e41a0f96c68f”,
  “name” : “ Sales_Discussion_1458”,
  “partnerId” : 234567,
  “reason” : “”,
  “sessionId” : “1_MX40NDcyNDAyMn5-
V2VklEp1bCAxNiAyMTo0NTowMyBQRFQgMjAxNH4wLjA1NDA0-
Mjlyfn4”,
  “size” : 0,
  “status” : “started”,
  “url” : null
}
```

At step f8s4 the meeting controller 7 notifies both devices that recording has started. Audio is played by the app stating “This part of the meeting is now being recorded” and the GUI is modified as apparent to the reader.

TABLE 23

```
From Cloud to Host & Participant
SbxStartRecordingResponse = {
    archiveID = “bdf9ccac-d94d-4dc4-9be2-254c679dd1ed”;
    statusList = {
      “@size” = 1;
      status = {
        statusCode = 1006;
        statusMessage = “Started Recording”;
      };
    };
  }
```

At step f8s5 the button to stop recording is activated at the GUI presented at the host device 2. The host device 2 sends a request to the meeting controller 7 to stop recording. The request includes the recording ID, token and action. The action is either confirm (keep recording) or delete (delete recording).

TABLE 24

From Host to Cloud
{“SbxStopRecordingRequest” : {“archiveID” : “bdf9ccac-d94d-4dc4-
9be2-254c679dd1ed” , “token” :
“34363035333839373030373134373138” , “action” : “Confirm”}}

At step f8s6 the meeting controller 7 notifies the video service to stop recording.

TABLE 25
1. From Cloud to Video
https://api.xxxx.com/v2/partner/<api_key>/archive/<archive_id>/stop

At step f8s7 there is no response from the Video Service.

TABLE 26

1. From Video to Cloud
No response

At step f8s8 the controller 7 communicates a notification to both parties to stop recording. Audio is played stating “The recording has now stopped” and the GUI is modified.

TABLE 27

```
From Cloud to Host & Participant
SbxStopRecordingResponse = {
    statusList = {
      “@size” = 1;
      status = {
        statusCode = 1007;
        statusMessage = “Stopped Recording - Confirm Action”;
      };
    };
  }
```

At step f8s9 the meeting controller 7 sends a request to the storage service 6 to either delete the recording, or to move it to a folder referenced to the specific online meeting.

Once the video has been recorded the video cloud service 5 communicates a link to the video to the meeting controller 7. A link in this embodiment is code defining a url or address. The controller 7 cloud service then copies the video to storage 6 and updates the CRM 4 with the link to the video in storage 6. A user of the CRM 4 can now access the video stored independently of the video service and under control of the meeting controller 7 or CRM 4 via the controller 7. The video can be referenced an retrieved by the online meeting, such as by the meeting ID.

TABLE 28

1. From Cloud to Storage
Java API Call

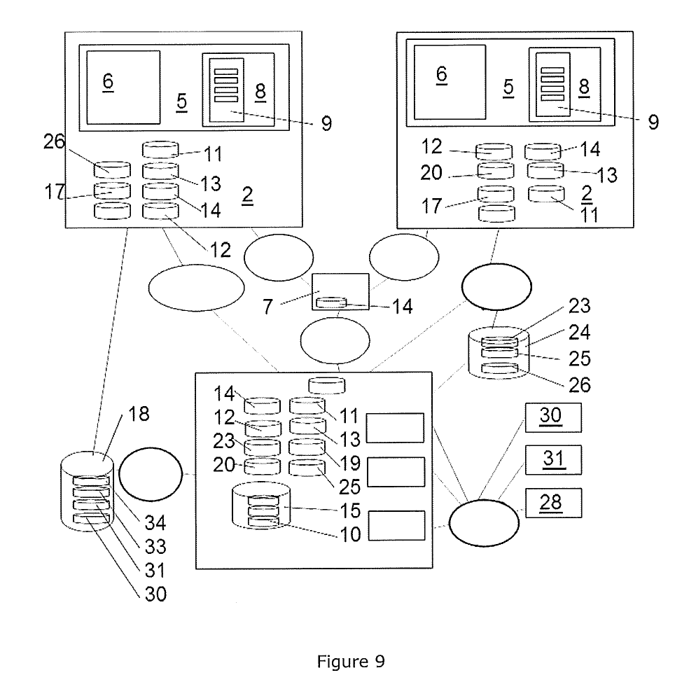

FIG. 9 shows a process by which the apps running on the devices 2 and 3 and the controller 7 to maintain status for the on-line meeting and by which the controller 7 enables the app running on the host device 2 to control the app running on the device 3. The apps running on devices 2 and 3 and controller communicate using the commands of the library 8.

At step f9s1 the template of a ‘heartbeat’ message is sent from either device 2 or 3 to the controller 7.

TABLE 29

| | |
|---|---|
| 1. | From Host or Participant to Cloud |
| | {“SbxHeartbeatRequest” : {“token” : |
| | “35313534393039393334323233303336”, “status” : |
| | “##status code” , “statusMessage” : |
| | “##status message”}} |

At step f9s2 the response communicated by the meeting controller 7 to either device 2 or 3 in response to a heartbeat, in the form of code from the library 8.

TABLE 30

| | |
|---|---|
| 1. | From Cloud to Host or Participant |
| | SbxHeartbeatResponse = { |
| | statusList = { |
| | “@size” = “##”; |
| | status = { |
| | statusCode = “#status code”; |
| | statusMessage = ”#status message”; |
| | }; |
| | }; |
| | } |

At step f9s3 the participant device 3 sends a token and status message to the meeting controller 7.

TABLE 31

| | |
|---|---|
| 1. | From Participant to Cloud |
| | {“SbxHeartbeatRequest” : |
| | {“token” : “35313534393039393334323233303336”, “status” : “” , |
| | “statusMessage” : “”}} |

At step f9s4 the meeting controller communicates a response.

TABLE 32

| | |
|---|---|
| 1. | From Cloud to Participant |
| | SbxHeartbeatResponse = { |
| | statusList = { |
| | “@size” = “”; |
| | status = { |
| | statusCode = ; |
| | statusMessage = “”; |
| | }; |
| | }; |
| | } |

Table 33 shows a list of commands in the library 8 used in communications between the apps running on devices 2 and 3 and the controller 7. The commands are generally accompanied by data carrying keys, status values, parameter values, IDs and various other information as will be apparent to the reader.

TABLE 33
Heartbeat Codes

| | |
|---|---|
| 200 | Ok |
| 201 | Created |
| 202 | Accepted |
| 206 | Partial Content |
| 400 | Bad Request |
| 401 | Unauthorised |
| 404 | Not Found |
| 408 | Timeout |
| 409 | Conflict |
| 410 | Gone |
| 419 | Authentication Timeout |
| 500 | Internal Server Error |
| 502 | Bad Gateway |
| 503 | Service Unavailable |
| 504 | Gateway Timeout |
| 522 | Connection time out |
| 901 | Download |
| 940 | Cancel |
| 941 | Closed |
| 1000 | Waiting for meeting to start |
| 1001 | In the Meeting |
| 1002 | In the Meeting/Recording |
| 1003 | Meeting ended/Recording stored |
| 1004 | Meeting ended/Recording discarded |
| 1005 | Meeting ended |
| 1006 | Started Recording |
| 1007 | Stopped Recording |
| 1008 | OpenTok Unavailable |
| 1009 | Downloading document |
| 1010 | Document downloaded |
| 1011 | Exsalerate Unavailable |
| 1012 | Archive deleted |
| 1013 | Invalid activity ID |
| 1014 | Invalid Credentials |
| 1015 | Service Unavailable |
| 1016 | Invalid ArchiveID |
| 1017 | Invalid User ID |
| 1018 | Invalid Token |
| 1019 | OpenTok Exception |
| 1020 | Invalid Session ID |
| 1021 | Invalid Meeting ID |
| 1022 | Unsupported Stop Recording Action |
| 1023 | Recording stored by callback |
| 1024 | Recording discarded by callback |
| 1025 | Host meeting token |
| 1026 | Participant meeting token |
| 1027 | Session ID |
| 1028 | Centre Coordinate\|Zoom Level |
| 1029 | Document listing provided |
| 1030 | Changed Video Position |
| 1031 | Recording listing provided |
| 1032 | Amazon S3 Exception |
| 1033 | Started Download Document |
| 1034 | Host has control |
| 1035 | Participant has control |
| 1036 | Host disconnected |

In this embodiment an online meeting involves an online meeting communication link established through exchange of a commands, from library commands, between the apps and devices 2 and 3 and a video session initiated by the controller. In this embodiment commands are predefined code which are stored in a library on both apps and the cloud stack.

The apps generate a GUI which combines browser forms generated by the apps, documents, data and menus stored by the CRM 4 and video streams provided by the video service as a video communication session.

In this embodiment the app can also talk directly with the video service once a video meeting is in session. This reduces steps and latency in the communications.

It will be apparent to the reader that the processes described above in reference to an embodiment of the present invention commence with a meeting request from the CRM 4 which contains CRM data. This allows online meetings to be setup using CRM data and, in some cases, from within a CRM user interface (not shown).

In some embodiments the login request received by the controller from a host device carries validation data in the form of a username and password. In some embodiments the validation data is stored by the relationship manager. In other embodiments the validation data is communicated to the controller and stored by the controller.

In various embodiments the devices and controller communicate using requests and responses. In various embodiments the requests and responses each carry a command in code defined in a library of code accompanied with data to affect the command. In some examples the command identifies a function or method to be executed by one of the actors in the system 1. In some examples the data is carried as an argument or attribute of the function or method.

In various embodiments the controller is able to communicate with the CRM and/or video service using code and endpoints defined by the APIs of these services.

The reader will appreciate that documents, data or videos stored by a relationship manager or CRM may be stored using a storage service, or other storage, and accessible to the CRM. For example, in some embodiments the relationship manager may store a link to documents, data or videos. The relationship manager of some embodiments stores the data, documents or video with associations to various of the following: enterprise, host, participants, online meeting and video session.

FIG. 9 shows a system 101 according to one embodiment of the present invention for an online meeting between a host device 102 and a participant device 103 in which the meeting is facilitated by an online meeting transaction server 104. The system of FIG. 9 allows a form to be filled in collaboratively and executed in the online meeting under the control of an operator of the host device 2. The form may be stored as evidence of as evidence of a transaction made in the online meeting involving data entered in the form.

According to the embodiment of FIG. 9 the host and participant devices 102 and 103 each have a user interface 105. The user interface 105 has a video interface 106 for connection with the other device through a video service 107. The user interface 105 also has a form interface 108 which displays a document or form 109 to be completed and signed in the online meeting as evidence a transaction made during the online meeting or in an online meeting room between operators of the devices 102 and 103.

The server 104 has a store 115 of form templates 110 which can be selected by inputs at the user interface 105 of the host device 104. The form interface 108 is able to render the form 109 from the template 110 downloaded to the device 102 or 103 from the server 104. The interface 105 of the participant device also uses configuration data 111 to render the form 109. The configuration data 111 is determined by inputs at the interface 105 at the host device 2, received at the server 104 and sent to the participant device 109. The operator of the host device 102 is able to control how the form is displayed or, in other embodiments, how the user interface 106 appears by determining or adjusting the configuration data 111. In this example, which fields of the form that are visible at any given time are determined by the configuration data. In this example also, various options which will be apparent to the reader for interaction with or display by the user interface 105 are also set as active or inactive by the configuration data 111.

In the embodiment shown in FIG. 9 moderation status data 113 controls which of the devices 102 or 103 has the authority to enter data into the device at a given time. In this embodiment also, the moderation status data 113 is determined by inputs at the user interface 105 of the host device. This provides the operator of the host device with further control of the online meeting. In one example, the moderation right, or moderator status, can be swapped between the two devices dependent under the control of the host device by inputs received at the user interface of the host device causing commands to swap the moderator status to be selected from the library and sent to the server.

FIG. 9 shows form data 112 stored at the host device 102, participant device 103 and server 104. Form data 112 entered into fields of the form 109 is stored locally at devices 102 or 103 for use in displaying the form 109 and is uploaded to the server 104 which downloads that form data to the other device 103 or 102 in the meeting. By this means the interfaces 105 of each device 102 or 103 show the current status of the form being filled.

Session data 114 held by the server 104 for a given online meeting session is downloaded to the devices 102 and 103 to authorise access to a session. In this embodiment the session data is associated with form data 112 entered in a session.

In the embodiment shown in FIG. 9 the server is operable to receive and send commands to and from the devices 102 and 103 to facilitate the meeting, update displays at the devices and data held at the devices and to allow the operator of the host device 102 to invite participants, control the meeting and cause the server to store form data. The commands are selected from a library of commands 17 held at each of the devices 102 or 103 and the server 104. The exchange of these commands between the server and the two devices in the online meeting allow initiation of an online meeting, selection of the participant, invitation of the participant and control of the online meeting in which the form is filled in and signed, and then initiates evidential storage of the form as a record of a transaction made in the meeting.

FIG. 9 also shows the server 104 in communication with a relationship database 118 which stores relationship data 134 which associates the host device or operators of host devices with an enterprise. The relationship data also associates operators which may be invited to participate using various candidate participant devices in a meeting with one of the host operators. In this embodiment the relationship database 118 stores data associating a number of candidate host devices 102, operators of host devices, or hosts, with the enterprise. The relationship database 118 of this embodiment also stores data defining associations between a number of candidate participants, for online meetings with the hosts associated with the enterprise. These candidate participants can be invited to an online meeting by the server 104 upon receiving a request from a host device 102. Additionally, in the embodiment of FIG. 1, the relationship database stores address data, such as 130 and 131, and is other data understood by the reader as required by the server 104 to generate an invite for an operator of a participant device to use to join the device 103 to an online meeting, typically, initiated by the server upon receiving a request from the host device 102. Data stored by the relationship database may also allow the server to associate a given host with a given enterprise. The server 104 of this embodiment allows host 102 devices 102, or operators of host devices, to initiate online meetings with participant devices 103 associated with the same enterprise. The server similarly allows participants to be invited to a meeting facilitated by the server.

The server has access to stored evidencing rules 119 which determine operations to be performed by the server at the request by the host, for example, that the form data be stored as evidence of a transaction made between operators of devices 102 and 103 in an on-line meeting. In this embodiment the server is able to receive commands from a number of host devices associated with a number of enterprises. The server of this embodiment is able to retrieve a set of rules 119 stored for each enterprise. The set of rules in this embodiment are associated with each host. In this embodiment also a stored association between the host and an enterprise and a set of rules defined for each enterprise allows the retrieval of a set of rules for the given host. Data from the relationship database 118 allows the server to retrieve the rules defined for the appropriate enterprise by associating the host with which the server is communicating with an enterprise.

In this embodiment a interfaces (not shown) is provided to allow evidencing rules to be received as inputs to a user interface or as a file or code. In this embodiment also a rules interface allows the rules to be displayed and or/updated.

In the embodiment shown in FIG. 9, a document generator 121 is operable to generate a document containing form data entered at the form interfaces 108 of the devices 102 and 103 and signature data entered, typically but not necessarily, only at the participant device 103 In this embodiment the signature data is captured as a set of coordinates of a pen, finger or pointing device of an operator of the participant device 103, or captures another activity which symbolised signing of the form.

Typically whether or not to generate a document is defined by the set of rules 19. The document generator of this embodiment also uses the form template for the respective form 109 downloaded to the devices 102 and 103.

FIG. 9 also an email client 122 which is operable to generate emails, typically using addresses retrieved from the relationship database. In this embodiment generating emails is an operation defined in evidencing rules 19 for a given enterprise.

FIG. 9 also signature data 123 captured at a device, typically the participant device 103, and associated with the form 109. In this specific embodiment a signature data store 124 is separate from the server 104. The server receives a signature link 125 to the signature data 123 to allow the server to upload the signature data 123. The host device receives a notification 126 from the signature data store 124 and/or participant device 103 when a signature associated with a form 109 has been captured and stored.

In this embodiment the evidencing rules 119 are particular to a given enterprise. In this embodiment also the rules define storage and transmission operations defining evidencing of the collaboration of the form in the online meeting, or the transaction represented by the form, by the server.

In the example of FIG. 9 the stored rules define the following operations for the server: that the server renders the form data and signature data uploaded into a document, such as a pdf, and sends a copy from an email server to addresses for the host and participant retrieved from the relationship database 118, to generate and transmit form status data 120 associated with form and signature data to the relationship database 118 and to store the form data and signature, to a storage endpoint at a cloud storage service for the enterprise, and to send a link to the CRM to allow access to data stored by the server or by an operator of a host device or party associated with the enterprise by the CRM, for example.

In some embodiments session data 114 held by the host and participant devices and by the server to identify a particular session of an online meeting. The session data may be used to aggregate form data as entered during a given session. In this embodiment the session data may be a session token of an address for a signature entered in the session.

FIG. 9 also shows a form template 110, defined in this embodiment in code in a mark-up language such as XML, for a form to be used to enter data at the host and participant devices. The form includes fields which receive entries of form data. The form template also defines the layout of the form. The form template allows the form data and signature to be rendered into a document or presented at the form display. The server of this embodiment stores a set of forms. Inputs at the host device result in selected commands from the library of commands which select a form template for the server to upload to the devices for collaboration in an online meeting. The template is used by the server to manage form data received from the devices and to render the form data into a form document to be sent to email addresses associated with the host and participant devices.

The server shown in FIG. 9 has a document generator 121 which generates, or renders, a document in a standard format such as .pdf using the form template 9 selected by the host device, form data entered into fields of a form displayed at the devices, and signature data captured at the participant device.

The server of FIG. 9 also has an evidential storage interface 127 which is operable to generate evidential data transmissions dependent on the set of evidencing rules 119 for the enterprise associated with the host. The evidential storage interface 127 of this example generates an evidential storage data transmission for a cloud storage service 128 at and endpoint defined in the rules 119 or, in alternative embodiments, retrieved from the relationship database 118.

In this embodiment the evidential data transmission is also generated dependent on address data 31 stored for the participant in the meeting, which is retrieved by the server 104 from the relationship database 18. In this example the evidencing storage interface stores at suitable endpoints form data, and signature data along with a session or meeting key and time stamps. The endpoints of this embodiment are endpoints of a cloud storage service 128 specified in the evidencing rules or, in alternative embodiments, in data separate data stored for a given enterprise. The evidencing storage interface transmits a link 133 to that data to the relationship database.

The server 104 of FIG. 9 also includes an email interface 121 which is operable to send emails dependent on the evidencing rules 119 and addresses 130 and 131 retrieved by the server 104 from the relationship database 118. In this example, the email client generates emails with addresses to host email address 130 and participant email address 131. These email addresses are retrieved from the relationship database 118 and the email carries a copy of the document rendered using the form template used in the online meeting between host and participant, the form data entered in the online meeting and signature data entered for the form by the participant.

In alternative embodiments, form data entered at a device may be sent directly to another device in an online meeting with a copy being sent to the server.

In some embodiments the functionality of the devices 102 and 103 are provided by a computer programme running on the device. In some embodiments the programme is provided in the form of instructions which are stored in a programme memory of the device, the programme is run on a processor of the device and uses a working memory of the device. In some embodiments the system, devices and server are configured by or follow processes defined in code and/or data stored on a storage medium. In some embodiments the code and/or data is configured or transmitted using any suitable format known to the reader. In some embodiments the code and/or data is provided as a software product.

In some embodiments the form displayed using a form template may be displayed differently in the form interface of the host device 102 than of it is displayed in the form interface 105 of the participant device.

In some embodiments evidencing rules may be specific to specific forms or defined types of forms.

In some embodiments a signature notification data is sent to the host device in lieu signature data and the user interface of the host device indicates that a form has been signed. However, in other embodiments the signature may be sent to the host device. This may be in combination with a signature flag or signature link.

In some embodiments the configuration data 111 enables or disables functions of the form display 109 and/or which fields of a form 109 displayed using a template 110 are enabled for data entry or visible.

In the present embodiment communications between the devices involving the form are in parallel to a video connection between the devices. In this embodiment also the video connection between the devices is established by the server with a video service and data allowing the devices to join the session is sent to the devices. In this embodiment the video session is established at the request of the host device.

In some embodiments session data held by the host and participant devices and by the server to identify a particular session of an online meeting. The session data may be used to aggregate form data as entered during a given session. In this embodiment the session data may be a session token of an address for a signature entered in the session,

It will be apparent to the reader that in some embodiments the exchange of commands may be additional to and external to data exchanged by the devices.

It will be apparent to the reader that the embodiment described above uses two communications links, provided via the video service and the controller using commands and combines these in a GUI generated by the app. In this embodiment the GUI of the app running on the participant device 103 is controlled by the app running on the host device 102 using commands selected from the library 108 and through the controller 107.

Embodiments of the present invention allow the apps on the host device 102 and participant device 103 communicate with each other through two parallel communication links for video communications and meeting control communications respectively.

In alternative embodiments, a number of participants or even hosts may be included in an online meeting or collaboration session. In alternative embodiments control or roles of the participant and host devices may be reversed or interchanged.

Alternative embodiments may use control-switch commands, control-switch data or control-switch flags which allow switching of control of user interfaces of devices communicating with the server in a session, meeting or room such that the user interfaces are synchronised and such that a subset of devices at any one time have control of updates to the synchronised display. In some embodiments the control-switch commands, control-switch data or control-switch flags are included in configuration data. In some embodiments the control-switch commands, control-switch data or control-switch flags define form-moderation status. In some embodiments the control-switch commands, control-switch data or control-switch flags are separate to configuration data.

In some embodiments configuration data is held centrally at the server, or a controller. In some embodiments the configuration data includes data entered at GUIs or captured from inputs at the GUI to for forms, documents. In some embodiments the configuration data includes a status at each of the devices.

Embodiments of the present invention have known alternative CRM services or applications to that disclosed above. In some embodiments data stored by the CRM is stored at a data store under control of the CRM.

The reader will appreciate that embodiments of the present invention comprise data media in the form of any combination of magnetic or optical storage media, EEPROM, static and dynamic RAM, and carrier media including electrical and optical signals.

Embodiments of the present invention comprise implementations using applications, cloud stacks, cloud services, software components and software modules and applications running on devices or a combination of these. It will be apparent to the reader that any of these implementations with functionality known to the reader to be suitable substitutions for or combinations of those described above in reference to aspects of the invention or embodiments of the of the invention may be substituted and/or combined without departing from the spirit, scope, pith or marrow of the invention.

Embodiments of the present invention comprise implementations using transmissions, sent and received requests transmissions, responses and queries using any suitable format or protocol known to the reader, including TCPIP, mark-up language files, WSDL, and JSON.

Embodiments of the invention comprise a device which has a processor, working memory and storage.

In some embodiments the device is a tablet running an operating system such as IOS, Android or Windows. In some embodiments the device has a touch screen which can capture, for example the act of a user marking their signature and which can capture data capturing that action.

In various embodiments the app or application installed on a device and operable to connect to applications running on a device is code running on a browser application installed on the device. In some examples the code is JavaScript. In some embodiments an invite or other transmission from the controller includes code to cause the browser or device to download further code or an application from an app store.

In various embodiments the host device has a direct link to the CRM or relationship database as shown by the dotted line n FIG. 1. In some of these embodiments the CRM or database may request meetings or rooms be initiated by the controller or a server at the request made by the host device to the CRM of database.

In various embodiments validation data may be login data.

In various embodiments validation data is transmitted to an address held by a relationship database or CRM for a host or participant and is used the online meeting application once a host or participant party operating a device makes the data available to the application.

The reader will appreciate that services mentioned herein refer broadly to any system or application providing an interface as a service. In some embodiments, services are interfaces provided by endpoints with functionality and syntax defined by an API.

In various embodiments the controller, such as illustrated with reference to FIG. 1, is a server. In some embodiments the controller, such as illustrated with reference to FIG. 1, has combinations of the additional functionality of the server as illustrated with reference to FIG. 9. Also in various embodiments the server, such as illustrated with reference to FIG. 9 has functionality as described herein to control devices, apps on devices and to control the video service.

In some embodiments a relationship database is a database which stores the relationship of two parties which may join an online meeting, such as the host and participant of a meeting. In some embodiments the database may be a Customer Relationship database. In some embodiments the parties may be identified as having given authority, such as being able to request that an online meeting or room be initiated.

In some embodiments the parties may have associated therewith a set of other parties that they may invite to a meeting or be invited to a meeting by. In some embodiments the database may store links to data associated with parties or with given meetings and/or rooms and/or video sessions.

In various embodiments the relationship manager, customer relationship manager, enterprise relationship manager are databases. In some of these embodiments the database includes a facility to store data and/or relations such as understood by the reader of databases. In various embodiments the database includes a facility to interact with other services, applications controllers and devices as described herein. In some examples the database may include a front-end as understood by the reader.

Embodiments of the invention comprise applications, cloud stacks, cloud services, software components and software modules and applications running on devices which communicate by any method, format or protocol known to the reader including JSon, WSDL, Rest, XML, TCIP, and Internet Message Access Protocol. It will be apparent to the reader that communications between actors in a system may comprise any known methods of machine communication such as transmissions, requests to addresses defined as endpoints in APIs, responses, queries, and updates.

Embodiments of the present invention comprise a software product, or carrier medium carrying instructions to perform any of the methods described herein in perform any of the processes performed herein, or to perform processes which configure hardware to perform processes or provide the apparatus described herein. For example, the instructions may be source or object code, or compiled firmware, or instructions in vary log or VHDL.

In the preceding description and the following claims the word “comprise” or equivalent variations thereof is used in an inclusive sense to specify the presence of the stated feature or features. This term does not preclude the presence or addition of further features in various embodiments.

Further, it is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention.

1-20. (canceled)

21. An online meeting controller operable to connect devices having installed an online meeting application which is operable to present a user interface for the device, wherein the user interface of each device is operable to display data and/or documents and/or video data from the other device so as to allow users at each device to participate in an online meeting, the controller being operable to:
communicate with a relationship manager which is operable to identify a user of a device as a host for an online meeting and identify a user of a device as the participant to be invited to the online meeting by the host, wherein the controller is operable to receive from the relationship management database first validation data which validates a device as a host device for an online meeting to be operated by a host of the meeting and second validation data which validates a device as a participant device to be operated by a participant invited to the online meeting;
communicate with a validated host device and a validated participant device so as to receive data input at the user interfaces of the host and/or participant devices and so as to synchronize the data and/or documents displayed at the user interfaces of the host and participant devices to allow the data and/or documents displayed at the host device and participant device in an online meeting to be updated; and
communicate with a video communication system operable to provide a video communication service between devices to initiate a video communication session through which the host device and the participant device can connect.

22. The online meeting controller of claim 21, wherein the controller is operable to communicate with the host and participant devices using a library of command code, wherein the library is retrievable by the controller and each device.

23. The online controller of claim 22, wherein the controller is operable to communicate commands to the video service in response to the controller receiving command code from the host device to allow the host to control one or more functions of the video service from the host device.

24. The online meeting controller of claim 23, wherein the controller is operable to control the video service to record video in response to command code received from the host device to start and stop video recording, operable to store the recorded video and operable to communicate a link to the relationship manager to allow the host operating the host device to control the capture of video from an online meeting.

25. The online meeting controller of claim 21, wherein the controller is operable to control the user interface of the participant device in response to command code received from the host device to allow a user interface at a participant device to be controlled by the host to control the online meeting from the host device.

26. The online meeting controller of claim 1, wherein the controller is operable in response to commands received from the host device to communicate a document or form selected from a set of documents to the participant device and to store a version of the document updated by inputs at the participant device.

27. The online meeting controller of claim 21, wherein the controller is operable to generate an invitation for a participant in response to a request received from the relationship manager, the invitation containing validation data to validate the participant device for an online meeting.

28. The online meeting controller of claim 1, wherein the controller is operable to store data and/or a document and/or a form updated in the online meeting by inputs at the user interfaces and operable to communicate to the relationship manager a link to the stored data and/or document.

29. The online meeting controller of claim 28, wherein the controller is operable to store the updated data and/or document and/or form in response to a command received from the host device and to store the data and/or documents dependent on a set of rules associated with the host.

30. The online meeting controller of claim 29, wherein the controller is operable in response to receiving a command from the host device to transmit the data and/or document and/or form using address data associated with the participant.

31. The online meeting controller of claim 21, wherein the controller is operable to synchronize data and/or documents and/or forms and store updated data and/or documents and/or forms received at the host or participant device in association with an identifier and/or key which persists over a two or more video sessions to provide an online room in which data and/or documents and/or forms can be updated between video sessions.

32. A process carried out by an online meeting controller for controlling an online meeting, wherein the process connects devices having installed an online meeting application which is operable to present a user interface for the device, wherein the user interface of each device is operable to display data and/or documents and/or video data from the other device so as to allow users at each device to participate in an online meeting, the process including the steps of:
communicating with a relationship database storing data which identifies a user of a device as a host for an online meeting and identifies a user of a device as the participant to be invited to the online meeting by the host;
receiving from the relationship database validation data which validates a device as a host device for an online meeting to be operated by a host of the meeting and validates a device as a participant device to be operated by a participant invited to the online meeting by the host;
communicating with a validated host device and a validated participant device so as to receive data which is input at the user interface of the host or participant devices and so as to synchronize the data and/or documents displayed at the user interfaces of the host and participant devices to allow the data and/or documents displayed at the host device and participant device in an online meeting to be updated; and
communicating with a video communication system which provides a video communication service between devices, wherein the controller communicates with the video communication service so as to initiate a video communication session through which the host device can connect with the participant device.

33. An online meeting controller operable to connect devices having installed an online meeting application which is operable to present a user interface for the device, wherein the user interface of each device is operable to display a form data entered at one or more of the devices so as to allow users at each device to participate in an online collaboration, the online meeting controller being operable to:
communicate with a relationship manager which is operable to identify a user of a device as a host for an online meeting and identify a user of a device as the participant to be invited to the online meeting by the host, wherein the online meeting controller is operable to receive from the relationship management database validation data which validates a device as a host device for an online meeting to be operated by a host of the meeting and which validates a device as a participant device to be operated by a participant invited to the online meeting;
store the form data and the signature data;
communicate with the application running on a validated host device and a validated participant device so as to synchronize the user interfaces at the host and participant devices and so as to receive form data entered in fields of forms displayed at the user interfaces of the host and participant devices and so as to receive signature data capturing a signature made at one or more of the devices;
retrieve a set of stored evidencing rules associated with the host, the rules defining one or more operations for the online meeting controller and including one or more addresses and/or endpoints transmission of form data and signature data; and
generate an evidencing transmission carrying form data and signature data, wherein the evidencing transmission is generated dependent on the set of evidencing rules associated with the host.

34. The online meeting controller of claim 33, wherein the evidencing rules are associated with the host through a stored association between the host and an enterprise, the association stored by a relationship manager.

35. The online meeting controller of claim 33, wherein the controller is operable to communicate with a video communication system which provides a video communication service between devices, wherein the controller communicates with the video communication service to initiate a video communication session through which the host device can connect with the participant device.
